(19) United States
(12) Patent Application Publication
(10) Pub. No.: US 2002/0160193 A1
(43) Pub. Date: Oct. 31, 2002

(54) Noble metal clad Ni/C conductive fillers and conductive polymers made therefrom

(76) Inventors: Karel Hajmrle, Fort Saskatchewan (CA); Jones Y. Zhang, Edmonton (CA); Brian William Callen, Fort Saskatchewan (CA)

Correspondence Address: Gowling Lafleur Henderson LLP, Suite 4900, Commerce Court West, Toronto, ON, M5L 1J3, CA

(21) Appl. No.: 09/788,435

(22) Filed: Feb. 21, 2001

(51) Int. Cl. B32B 15/02

(52) U.S. Cl. 428/403; 428/408; 428/570; 523/215; 523/204

(57) ABSTRACT

There is provided a particulate conductive filler which comprises a noble metal coating formed over a non-noble metal coating over an inner carbon-based core. The conductive filler is used in conjunction with a polymer matrix to form composite materials for conductive applications.

### BACKGROUND OF THE INVENTION

(i) Field of the Invention

The present invention relates to a particulate conductive filler used in the preparation of conductive polymers for application in the manufacture of electronic components and the like.

(ii) Description of the Related Art

Conventional shielding products are used in electronic applications ranging from aerospace components to cellular telephones to provide protection from electromagnetic interference (EMI) and radio frequency interference (RFI). Typically, such shielding products were formed by the introduction of a conductive filler into a polymeric matrix based on the premise that reduced volume resistance (DC resistance) translates to an increase in shielding effectiveness. The trade journal article Interference Technology Engineers' Master ITEM 1999 “Correlating DC Resistance to the Shielding Effectiveness of an EMI Gasket” Thomas Clupper p. 59 produces theoretical models that relate shielding effectiveness to resistance. The EMI shielding effectiveness of two gasket materials and DC resistance across each gasket were measured while each gasket was mounted in a fixture. A resistance of 1 ohm was measured across the fixture for gasket A and 0.01 ohm was measured for gasket B. The EMI shielding effectiveness of gaskets A and B were measured at 65 dB and 42 dB respectively at 100 MHz, showing an increase in shielding effectiveness with reduced volume resistivity.

Initially, the conductive fillers were composed of solid noble metal particles. However, such fillers are extremely costly and attempts were made to develop more economic conductive fillers without the loss of shielding and conductivity properties. Less costly alternative materials consist of noble metals clad on comparatively inexpensive core materials such as glass, aluminum or copper. The use of noble metals are considered too costly for some applications. Subsequently, copper and nickel powders were used for this purpose, followed by the use of nickel clad graphite or carbon core particles. However, in these prior art fillers, the nickel to nickel contact between particles would not be as conductive as for noble metal or noble metal clad particles. This is due to the non-conductive nickel oxide layer which forms on the nickel to nickel contact surface.

In U.S. Pat. No. 5,284,888, there is disclosed an EMI/RFI shielding composition which comprises a polyurethane resin formed of two polymers having a stabilized conductive filler therein and an azole. The preferred filler is a silver stabilized copper powder.

Kalinoski et al. U.S. Pat. No. 6,096,413 describes a conductive gasket formed of silicone urethane and/or thermoplastic block copolymers having a conductive filler associated therewith. The conductive fillers used to fill the elastomers can be selected from pure silver, noble metal-plated non-noble metals such as silver plated copper, nickel or aluminum. Non-noble metal-based materials including non-noble metal-plated non-noble metals are also suitable, exemplary of which would be copper-coated iron particles. In addition, non-metal materials such as carbon black and graphite and combinations thereof may be used.

An EMI shielding gasket using nickel coated graphite particles with EMI shielding effectiveness of at least 80 dB between 10 MHz and 10 GHz is described by Kalinoski in U.S. Pat. No. 5,910,524. The volume resistivity of this material is reported to be from about 500-1000 milliohm-cm.

### SUMMARY OF THE INVENTION

It is a principal object of the present invention to provide a particulate conductive filler comprised of a noble-metal plated coating on an intermediate non-noble metal plated coating over a carbon-based core. The particulate conductive filler is combined with a polymer matrix to produce a composite material from which the desired components may be manufactured.

It is a secondary objective of the invention to provide a conductive filler exhibiting improved EMI/RFI shielding and electrical conductivity properties.

In accordance with the invention there is provided a particulate conductive filler for use with a polymer matrix to form composite materials wherein each particle comprises:

a central carbon-based core having a non-noble metal coating; and

an outer noble metal coating on said non-noble metal coating.

The invention further extends to a composite material comprising; a polymer matrix having a filler therein which comprises particles formed of a central carbon-based core having a non-noble metal coating therearound; and an outer noble metal coating surrounding said non-noble metal coating. Carbon-based core refers to core material compositions that are greater than 50% carbon.

Advantageously, as a result of practicing this invention, such as by providing a silver coating on a nickel coating on a graphite core, there is provided:

a conductive filler that is significantly more conductive than prior art Ni/C;

a conductive filler that has enhanced EMI shielding properties as compared to Ni coated graphite;

a conductive filler that has the benefit of particle shape and hardness associated with Ni/C; when used as a filler in polymers the Ni/C forms good electrical contact as it can penetrate oxide layers on flanges;

a conductive filler that has a low particle density compared to nickel; low density conductive fillers are sought for applications in light-weight materials and for reducing costs;

a conductive filler that has magnetic properties because of Ni content.

Furthermore, the surface roughness and the internal crevices of the carbon substrate particles are filled out by the non-noble metal, thereby reducing the surface area needing to be covered by the noble metal and subsequently reducing the cost of the filler. The surface area of graphite with an average particle size of 120 microns was measured by nitrogen gas adsorption (multipoint BET method) to have a surface area of 1.83 m²/g. The same graphite when completely clad by nickel had a greatly reduced surface area of 0.09 m²/g.

Also, the Ni/C (graphite) composite powders are already in common usage making the introduction of the products of the invention relatively uncomplicated and inexpensive, i.e. the equipment and processes developed for Ni/C are directly applicable to the filler of the present invention.

In its broad aspect, the particles of conductive filler of the invention for use with a polymer matrix to form composite materials comprises a central carbon-based core of composition greater than 50% carbon by weight, a non-noble metal coating on said central carbon-based core, and an outer noble metal coating on said non-noble metal coating. The central carbon-based core is selected from the group consisting of natural graphite, synthetic graphite, carbon black and mixtures thereof. The non-noble metal is selected from the group consisting of nickel, copper, aluminum, tin, cobalt and zinc. The noble metal is selected from the group consisting Ag, Au, Pt, Pd, Ir and Rh and alloys thereof. Preferably, the non-noble metal coating is nickel and said central carbon-based core is natural graphite or synthetic graphite, the nickel comprising between 5 and 90 weight % of the particle and encapsulating the carbon-based core. The noble metal preferably is silver or gold and comprises about 1 to 40% by weight of the particle and encapsulates the nickel. A composite material of the invention comprises a polymer matrix having a filler therein which comprises the particles formed of a central carbon-based core, a non-noble metal coating on said central carbon-based core, and an outer noble metal coating on said non-noble metal coating, the polymer matrix preferably being silicone polymer.

In its broad aspect, method of the invention for providing EMI shielding for application to a substrate comprises the steps of forming a composite of a polymer matrix and said particulate filler uniformly dispersed in the polymer matrix, said particulate filler consisting essentially of a central carbon-based core of composition greater than 50% carbon by weight, a non-noble metal coating on said central carbon-based core, and an outer noble metal coating on said non-noble metal coating. Preferably, the non-noble metal is nickel and the central carbon-based core is natural graphite or synthetic graphite, said nickel constituting 5 to 90 weight % and encapsulating the carbon-based core, and the noble metal is gold or silver, said gold or silver constituting 1 to 40 weight % and encapsulating the nickel.

### DESCRIPTION OF THE DRAWINGS

FIG. 1 is a cross-sectional view of the Ni/C particles used in the preparation of the conductive fillers of the prior art; and

FIG. 2 is a cross-sectional view of an embodiment of conductive filler particles of the present invention.

### DESCRIPTION OF THE PREFERRED EMBODIMENT

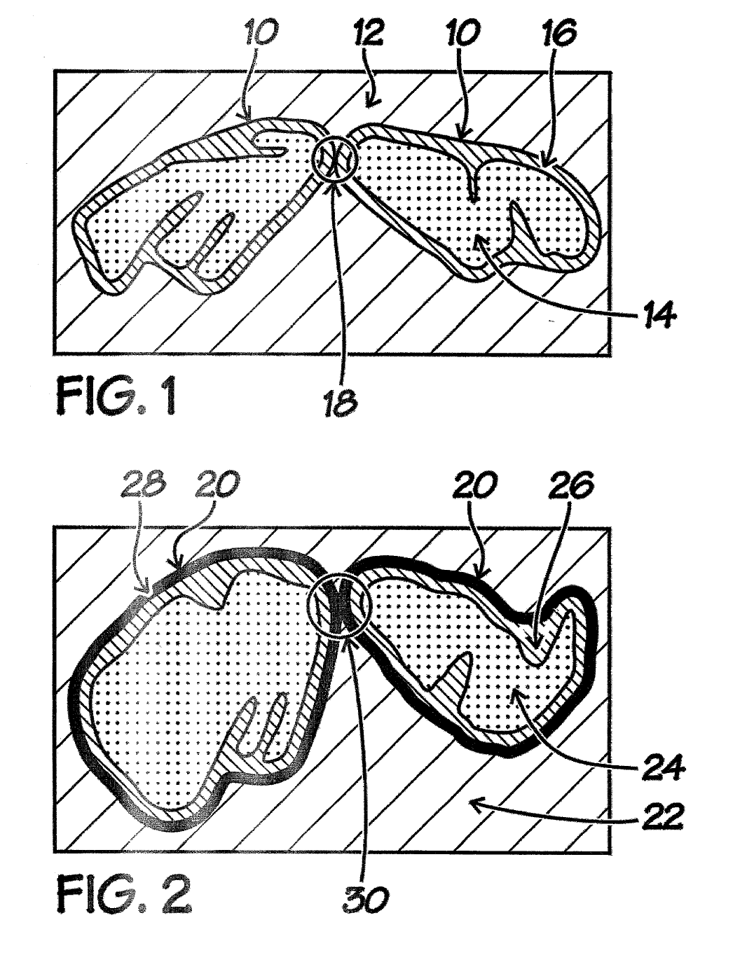

Having reference to the accompanying drawings, there is shown in FIG. 1 an example of the prior art conductive particles 10 used as the filler in a polymer matrix 12. The conductive particles 10 comprise an inner graphite core 14, having a nickel metal coating 16 thereon. The contact area between contiguous particles is designated by numeral 18.

FIG. 2 depicts the conductive filler particles 20 of the present invention in a polymer matrix 22 wherein the carbon-based core 24 has a non-noble metal coating 26 and an outer noble metal coating 28. Contiguous conductive particles have a contact area designated by numeral 30.

The inner core 24 may be formed of any suitable carbon-based particulate material such as natural graphite, synthetic graphite, carbon black or mixtures thereof having greater than 50% by weight carbon and having an average size in the range of about 1 to 300 microns. The non-noble metal 26 may be selected from nickel, copper, aluminum, tin, cobalt or zinc.

In the embodiment illustrated in FIG. 2, the inner core is natural graphite and the non-noble metal is nickel. The nickel coating 26 is applied to the graphite core using conventional techniques well-known in the art (carbonyl process, electroless plating, hydrometallurgy, and the like) preferably to provide continuous encapsulation of the carbon core. Ni/C particles such as those manufactured by hydrometallurgy may be utilized. The nickel coating is functional to provide bulk conductivity from particle to particle and to substantially reduce the surface area required to be coated by the noble metal. Although it is preferred to completely encapsulate the carbon core with the non-noble metal, it will be understood that desired conductivity or EMI shielding effectiveness may be attained with partial cladding of the carbon core by the non-noble metal, in which case the carbon core is partially encapsulated by the non-noble metal.

The noble metal is plated onto the non-noble metal Ni/C particles to thereby form the noble-metal plated, non-noble metal coated graphite core. Suitable noble metal are selected from silver, gold, platinum, palladium, rhodium, iridium or their alloys. The preferred noble metals are silver and gold. Preferably, the noble metal content ranges between 1-40% by weight, but most preferably is kept as low as necessary to effect the requisite conductive properties. The amount of silver depends mainly on the particle size, particle shape, non-noble metal concentration, surface roughness and core density. The amount of noble metal coating would need to be sufficient to assure conductivity. It is recognized that conductivity may be assured by only partially cladding the particle with noble metal, in which case the particle would not be completely encapsulated by the noble metal. Preferably, the non-noble metal content ranges from about 5 to 90% by weight and depends on core particle shape, size, surface roughness and core density.

The polymer matrix includes, but is not limited to silicones, epoxies, urethanes, fluoropolymers and acrylics.

The particulate conductive filler of the invention may be mixed with other particulate conductive fillers such as typified by silver-coated glass spheres to impart improved flow characteristics to the polymer matrix.

The particulate conductive filler and the composite material of the invention will now be described with reference to the following non-limitative examples.

### EXAMPLES

### Example I

Nickel coated graphite powder (Ni/Graphite) of composition 65% by weight Ni and 35% by weight graphite with an average particle size of 120 microns was used as a baseline conductive powder filler. Ni/Graphite powder of the same composition was coated with 10% by weight silver by the well-known technique of replacement reaction in cyanide solution. Each of the two powder samples was measured for volume resistivity by pouring them into a plastic cylinder followed by the cylinder being tapped to settle the powder. Volume resistivity was measured with a four-point probe (Keithely™ model 580 micro-ohmmeter) by placing the electrodes at the top and bottom of the powder column:

| | Bulk Powder Volume |
|---|---|
| 120 micron Conductive Filler Type | Resistivity ohm-cm |
| Ni/Graphite | 11.2 |
| Ag coated Ni/Graphite | 0.0025 |

### Example II

Nickel coated graphite powder (Ni/Graphite) of composition 80% by weight Ni and 20% by weight graphite with an average particle size of 11 microns was used as a baseline conductive powder filler. Ni/Graphite powder of the same composition was coated with 10% by weight gold. Each powder was mixed with GE Silicone RTV 615™ in the proportion of 2.5 g powder plus 2.0 g RTV 615 component “A” and 0.5 g RTV 615 component “B”. The powder-filled silicone samples were poured into 8 cm diameter aluminum trays and cured at 65° C. for 1 hr. The volume resistivity of the cured rubber was measured with 4-point resistance probe (Keithely™ model 580 micro-ohmmeter) with electrodes spaced 2.54 cm apart: The calculation of volume resistivity accounted for the volume of rubber between the two electrodes that were pressed on the rubber surfaces.

| 11 micron Conductive Filler Type | Volume Resistivity ohm-cm |
|---|---|
| Ni/Graphite | 1.33 |
| Gold coated Ni/Graphite | 0.11 |

### Example III

Nickel coated graphite powder (Ni/Graphite) of composition 75% by weight Ni and 25% by weight graphite with an average particle size of 30 microns was used as a baseline conductive powder filler. Ni/Graphite powder of the same composition was coated with 5%, 10% and 20% by weight silver. Each of the four powder samples was measured for volume resistivity by the same method as Example I.

| | Bulk Powder Volume |
|---|---|
| 30 micron Conductive Filler Type | Resistivity ohm-cm |
| Ni/Graphite (30 micron) | 0.86 |
| 5% Ag coated Ni/Graphite | 0.013 |
| 10% Ag coated Ni/Graphite | 0.041 |
| 20% Ag coated Ni/Graphite | 0.0027 |

### Example IV

Conductive silicone rubber sheets were prepared as follows. Two powder samples of the compositions described in Example I were used. Each powder was mixed with a heat curable silicone resin polymer in a two-roll mixer to 62.0% by weight powder loading for the non-silver coated powder and to 62.85% by weight for the silver coated powder. The different weight loading used for the two powders was to correct for differences in particle density in order to prepare samples with the same filler volume loading of 29.16%. Each compound was cured and molded in a heated press to form square conductive silicone rubber sheets 15 mm wide and 1.8 mm thick. Volume resistivity of each conductive silicone rubber sheet was measured with a four-point surface probe described in Example II: The calculation of volume resistivity accounted for the volume of rubber between the two electrodes that was pressed on the rubber surfaces.

| | Conductive Rubber Volume |
|---|---|
| Conductive Filler Type | Resistivity milliohm-cm |
| Ni/Graphite | 17.3 |
| Ag coated Ni/Graphite | 3.5 |

### Example V

Nickel coated graphite fiber of composition 67.5% by weight Ni and 32.5% by weight graphite with an average fiber size of 200 microns long and 8.5 microns in diameter was used as a baseline conductive powder filler. Nickel coated graphite fiber of the same composition was coated with 15% by weight silver. Each powder was mixed with a two-part silicone liquid that is heat curable. The liquid silicone cures through heat to form a sponge elastomer. Each of the two test powders was mixed with the liquid silicone to 43.6% by weight loading. No adjustments were made for the differences in particle densities as was done in Example IV. Volume loading in the uncured silicone liquid was 15.2% for the sample with silver and 16.4% for the sample without silver. The samples were poured into moulds and cured at 150° C. for 1 hr. The samples were then removed from the moulds and post-cured at 150° C. for 1 hr. Seven foam cubes (15 mm×15 mm×15 mm) were cut from each molded sample. Volume resistivity of the cubes was measured with a 4-point resistance probe (Keithely™ model 580 micro-ohmmeter) connected to two brass plates with a pressure of 0.2 kg/cm².

| | Conductive Foam Volume |
|---|---|
| Conductive Filler Type | Resistivity milliohm-cm |
| Ni/Graphite fibre | 43.7 |
| Silver coated Ni/Graphite fibre | 5.8 |

### Example VI

Conductive epoxy resin samples were prepared as follows. Two powder samples of the compositions described in Example I were used. Each powder was mixed with epoxy resin (Caldofix™ by Struers) to 61.2% by weight powder for the non-silver coated powder and to 62.0% by weight for the silver coated powder. The different weight loading used for the two powders was to correct for differences in particle density in order to prepare samples with the same filler volume loading of 29.16%. Each compound was cured in cylindrical molds 2.54 cm in diameter and 1.25 cm tall in an air circulating oven at 95° C. for 18 hrs. The conductive epoxy resin samples were polished with 6 micron diamond slurry and then volume resistivity of each conductive epoxy resin samples was measured by the method described in Example V, except the pressure applied to the samples was 1.0 Kg/cm²:

| Conductive Filler Type | Conductive Resin Volume Resistivity ohm-cm |
|---|---|
| Ni/Graphite | 9.88 |
| Silver coated Ni/Graphite | 0.148 |

It will be understood, of course, that modifications can be made in the embodiments of the invention described herein without departing from the scope and purview of the invention as defined by the appended claims.

We claim:

1. A particulate conductive filler for use with a polymer matrix to form composite materials wherein each particle comprises:
a central carbon-based core of composition greater than 50% carbon by weight, a non-noble metal coating on said central carbon-based core; and
an outer noble metal coating on said non-noble metal coating.

2. The particulate conductive filler as set forth in claim 1 wherein said central carbon-based core is selected from the group consisting of natural graphite, synthetic graphite, carbon black and mixtures thereof.

3. The particulate conductive filler as set forth in claim 2 wherein said non-noble metal is selected from the group consisting of nickel, copper, aluminum, tin, cobalt and zinc.

4. The particulate conductive filler as set forth in claim 3 wherein said noble metal is selected from the group consisting Ag, Au, Pt, Pd, Ir and Rh and alloys thereof.

5. The particulate conductive filler as set forth in claim 1 wherein said non-noble metal coating is nickel and said central carbon-based core is natural graphite or synthetic graphite.

6. The particle conductive filler as claimed in claim 5 wherein the nickel is between 5 and 90 weight % and encapsulates the carbon-based core.

7. The particulate conductive filler as claimed in claim 6 wherein the noble metal is about 1 to 40% by weight silver and encapsulates the nickel.

8. The particulate conductive filler as claimed in claim 6 wherein the noble metal is about 1 to 40% by weight gold and encapsulates the nickel.

9. A composite material comprising; a polymer matrix having a filler therein which comprises particles formed of a central carbon-based core, a non-noble metal coating on said central carbon-based core, and an outer noble metal coating on said non-noble metal coating.

10. A composite material as claimed in claim 9 wherein said polymer matrix is silicone polymer.

11. A composite material as claimed in claim 9 wherein wherein said central carbon-based core is selected from the group consisting of natural graphite, synthetic graphite, carbon black and mixtures thereof.

12. A composite material as claimed in claim 11 wherein said non-noble metal is selected from the group consisting of nickel, copper, aluminum, tin, cobalt and zinc.

13. A composite material as claimed in claim 12 wherein said noble metal is selected from the group consisting Ag, Au, Pt, Pd, Ir and Rh and alloys thereof.

14. A composite material as claimed in claim 9 wherein said non-noble metal coating is nickel and said central core is natural or synthetic graphite, said nickel coating encapsulating the natural or synthetic graphite.

15. A composite material as claimed in claim 14 wherein said polymer matrix is silicone polymer.

16. A composite material as claimed in claim 14 wherein the noble metal is about 1 to 40% by weight silver.

17. A composite material as claimed in claim 16 wherein the noble metal is about 1 to 40% by weight gold.

18. A composite material as claimed in claim 16 wherein the core is between about 1 and 300 microns in size.

19. A method of providing EMI shielding for application to a substrate comprising the steps of forming a composite of a polymer matrix and a particulate filler uniformly dispersed in the polymer matrix, said particulate filler consisting essentially of a central carbon-based core of composition greater than 50% carbon by weight, a non-noble metal coating on said central carbon-based core, and an outer noble metal coating on said non-noble metal coating.

20. A method as claimed in claim 19 said central carbon-based core is selected from the group consisting of natural graphite, synthetic graphite, carbon black and mixtures thereof.

21. A method as claimed in claim 20 wherein said non-noble metal is selected from the group consisting of nickel, copper, aluminum, tin, cobalt and zinc.

22. A method as claimed in claim 21 wherein said noble metal is selected from the group consisting Ag, Au, Pt, Pd, Ir and Rh and alloys thereof.

23. A method as claimed in claim 19 wherein the non-noble metal is nickel and the central carbon-based core in natural graphite or synthetic graphite, said nickel constituting 5 to 90 weight % and encapsulating the carbon-based core, and wherein the noble metal is gold or silver, said gold or silver constituting 1 to 40 weight % and encapsulating the nickel.
